(19) United States
(12) Patent Application Publication
(10) Pub. No.: US 2012/0297702 A1
(43) Pub. Date: Nov. 29, 2012

(54) Laminate flooring Installing tool

(76) Inventors: Judson Columbus Hughey, Hixson, TN (US); Joseph Hossien Khalill, Hixson, TN (US)

(21) Appl. No.: 13/161,770

(22) Filed: Jun. 16, 2011

Related U.S. Application Data
(60) Provisional application No. 61/398,505, filed on Jun. 28, 2010.

(51) Int. Cl. B25B 27/02

(52) U.S. Cl. 52/127.5

(57) ABSTRACT

A universal tool for the installation of laminate floors that will utilize a section of the tongue or groove section of the floor being installed to remove gaps in the boards being joined together. The tool will be universal in that it will utilize the unique tongue and groove pattern of the different manufactures of the laminate floor being installed. The tool will be used as a highly specialized tapping block by applying force to remove the gaps without harming the integrity of the tongue and groove of the laminate boards being installed. The tool will include a template for cutting the section of tongue and groove from the floor being installed in order to fit precisely in the main body of the tool.

This application for a utility patent was first filed as a Provisional Patent 61/398,505 with a filing date of Jun. 28, 2010. The Confirmation Number is 8438.

### FIELD OF THE INVENTION

This invention would assist in the professional or do-it-yourself home owner in installing tongue and groove type laminate flooring regardless of the tongue and groove design.

### BACKGROUND

Laminate flooring is a popular flooring product due to its ease of installment compared to traditional hardwood flooring. Laminate flooring looks like hardwood but comes finished with no sanding or staining required. The flooring also comes in many different designs such as all types of wood and stone. The design is a printed layer in the laminate process so the possibilities are endless. This also makes this very popular with do-it-yourself (DIY) home owners as well. A few specialized products have been designed to ease installation of laminate flooring but none with great success.

Laminate flooring is durable but not indestructible. It is easier to damage a laminate floor in the install then daily living on it. Most install tools on the market today are very easy to chip the laminate or crush the tongue or grooves making that board a scrap piece.

Laminates come in either the glued or the non glued design with the non glued design becoming the most popular. Instead of glue to hold the boards together, the tongue and groove have a locking design to hold it in place. When joining two boards, you must take the tongue board and slide it into the groove at a 45 degree angle and push hard into the groove while lowering the new board to flat on the floor. The most common issue will be the gap that is left in between the boards. The locking design of the tongue and groove to avoid needing glue makes boards with gaps an extremely common issue and detracts from the integrity of the floor as well as the look of the finished install.

Most laminate flooring systems today have boards that are 7-8 inches wide and 4 feet long. They have a tongue or a groove on all four sides. When installing in a room, you make “runs” the length of the room by joining the boards end to end on the 7-8 inch side. You then join another “run” the same length end to end. You not take that “run” and join it along the long side of the first “run” you laid down. This is the point of the install where a tool is needed to eliminate the gap without damaging the laminate boards. It is a tremendous task to get that whole “run” in the groove with no gaps at the seam.

The current tools for the install of laminate flooring are deficient in the task of closing the gap in the “run” without damaging the flooring. One popular tool is a wood or polymer block to place touching the boards in the “run” being installed and tapping it together. This issue with this method is that the tongue or groove on the side that is being tapped in more often are damaged since the block is square and all the pressure is placed on the tongue or groove that will be needed for the next “run”. Only very little force can be used in this method to avoid crushing the groove which makes it ineffective in most locking design installs.

The other popular tool is a metal bar with a small lip on either end, one down and one up. This tool is used to lie on top of the laminate flooring placing one end hanging over the edge of the groove. This would be the same side the wood block but this tool just grabs the top ⅛ inch of the groove. You then would use a hammer to tap the other lip of the tool to push the gap closed. The issue with this tool is that all of the force of the hammer taps is on just the top ⅛ inch of the groove and will chip or break the finish off the flooring in the area that the tool touches.

These are really the only two current options for closing that board gap with a universal tool. There is no standard tongue and groove design used by laminate floor manufactures so designs will vary greatly from product to product.

What is needed is an invention that would be able to close the gap in the laminate floor boards during install that is caused by the tight tongue and groove design without damaging the tongue and groove or the finish of the boards being installed. What is further needed is an invention that can do this for all of the different tongue and groove designs from the different manufacturers. This invention would need to be a universal install tool for laminate flooring.

### SUMMARY

The present invention is a laminate floor install tool that will be universal in respect to the various laminate flooring tongue and groove locking system designs from different manufacturers. This invention will utilize a two piece construction consisting of a main body and a removable template that will be housed in the main body piece. The main body will be of a rectangular shape and will be able to be fitted with a section of tongue or groove from a scrap piece of the flooring that is being installed. The installer will be able to remove the inventions template from the main body of the invention and use it as a guide for cutting the tongue or groove piece from a scrap piece of the floor being installed. The template may be replaced back into the main body of the invention and the invention may be used with the template stored. The installer will then take that cut piece and fasten it into the main body of the invention using the inventions built in tightening system. The installer will then be able to insert the invention, using the unique tongue or groove design of the floor being installed, into the groove and use as a tapping block to eliminate the gap in between the boards being installed. A high level of force may be used in this task since the invention uses the exact tongue and groove design and not a flat block which will crush the grooves. This will also not chip the finish since the invention does not touch the finish of the boards being installed.

### BRIEF DESCRIPTION OF THE DRAWINGS

Accordingly, the present disclosure will be understood best through consideration of, and with reference to, the following drawings, viewed in conjunction with the Detailed Description of the Invention referring thereto, in which like reference numbers throughout the various drawings designate like structure, and in which:

FIG. 1 is a overhead view of the Laminate Floor Installing Tool in accordance to the present disclosure;

FIG. 2 is a front view of the Laminate Floor Installing Tool of FIG. 1;

FIG. 3 is an exploded view of the laminate floor clamping system on the front of the Invention of FIG. 1 and the side view of the template storage slot;

FIG. 4A is a top view of the template of FIG. 1 and

FIG. 4B is a side view of the template of FIG. 1.

It is to be noted that the drawings presented are intended solely for the purpose of illustration and that they are, therefore, neither desired nor intended to limit the scope of the disclosure to any or all of the exact details of construction shown, except insofar as they may be deemed essential to the claimed invention.

### DETAILED DESCRIPTION OF THE INVENTION

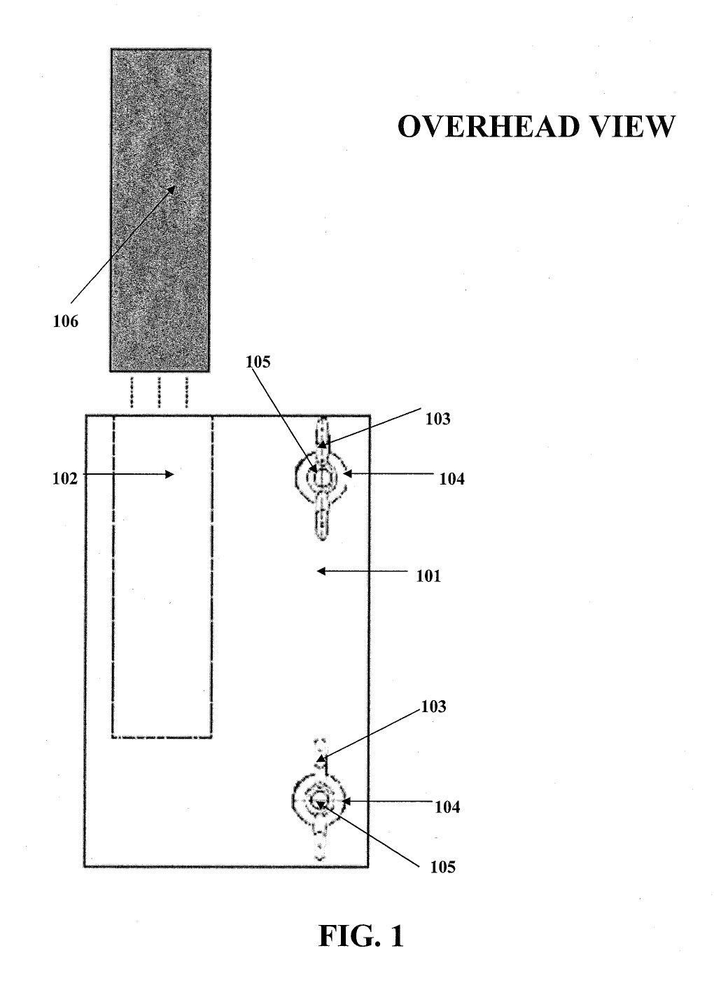

Referring now to FIG. 1, illustrated is an overhead view of the Laminate Floor Installing Tool according to the present disclosure, generally designated by reference number 101. Laminate Installing Tool 101 will hold securely a section of the laminate flooring that is being installed by means of two sets of tightening assemblies each of which will consist of a bolt 105, washer 104, and wing nut 103 in the front side of tool 101. FIG. 1 also shows a separate template 106 that will be stored in the body of the invention by sliding it into the side of invention 101.

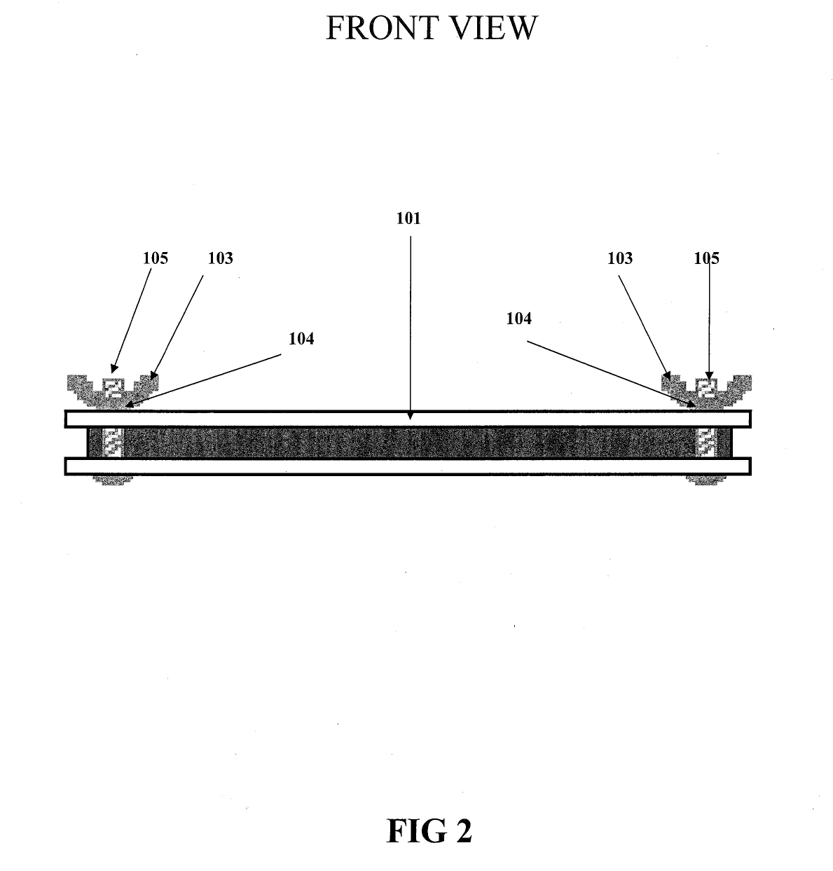

FIG. 2 is a front view of the Laminate Floor Installing Tool 101 which shows the two tightening assemblies which will consist of a bolt 105, washer 104, and wing nut 103. FIG. 2 also shows the open space between the bolts 105 in which a section of the laminate flooring that is being installed will be inserted into Laminate Floor Installing Tool 101 and held in place by tightening wing nut 103 on bolt 105 on both tightening assemblies.

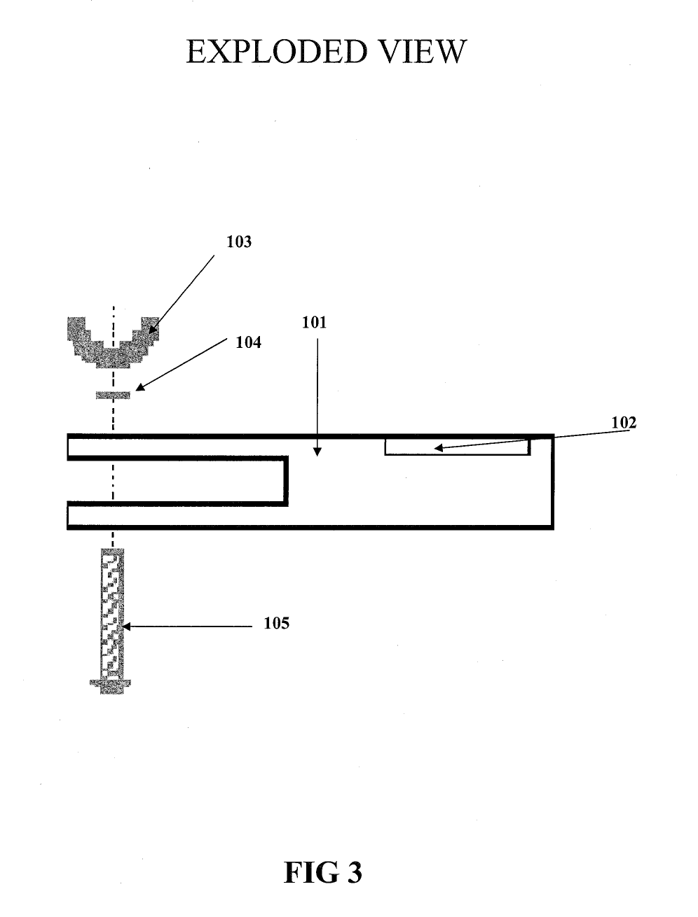

FIG. 3 is an exploded from the side perspective of Laminate Floor Installing Tool 101 of one of the two tightening assemblies. The parts of the tightening assemblies consist of a bolt 105, a washer 104, and a wing nut 103. FIG. 3 also shows the cutout slot in which the separate template 106 is housed in Laminate Floor Installing Tool 101.

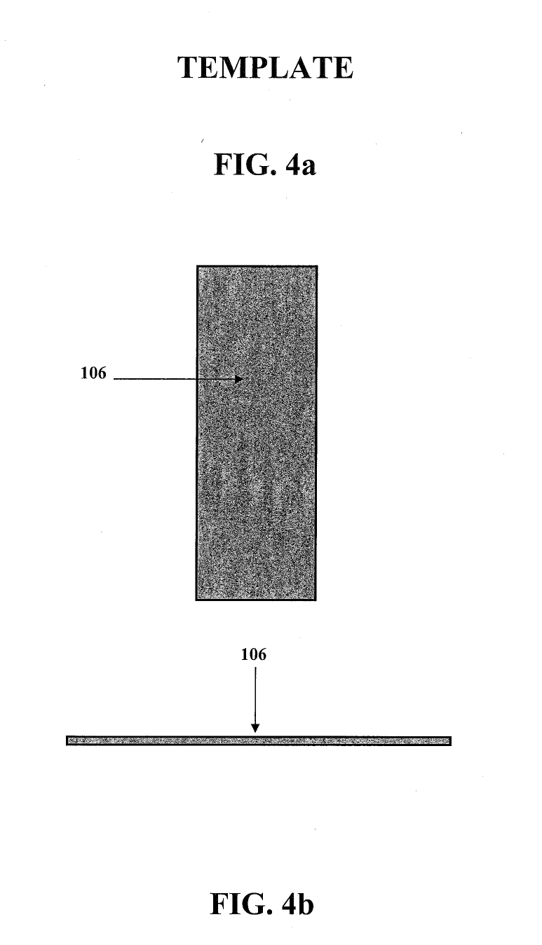

FIG. 4A is a top view of the template 106 of FIG. 1 that is housed in the cutout slot shown of FIG. 3. The purpose of template 106 is that it will be used to mark off the correct size section from the laminate flooring that is being installed. If this template is used, the flooring section will fit perfectly in the slot in between tightening assembly bolts 105 as shown in FIG. 2

FIG. 4B is a side view of the template 106 of FIG. 1 that is housed in the cutout slot shown of FIG. 3.

What is claimed is at least:

1. A tool comprising:
a main body that will consist of a construction that will utilize a the tongue or groove section of a laminate flooring being installed for the purposes of installing said floor; and
a plurality of items on the main body that will assist in the purposed stated above such as securing and measuring tongue or groove section.

2. The tool of claim 1 which comprises the main body will include an open slot along one edge in which a section of the tongue or groove from the laminate flooring being installed will be inserted and held securely by the inventions design.

3. The tool of claim 1 will have two tightening assemblies that will pinch the open slot on the laminate flooring tongue or groove section of the flooring being installed to hold it secure.

4. The tool as described in claim 3 will be able to be used in the following manner. The tongue or groove section held fast in the invention will be inserted into the row of laminate flooring being laid and used as a tapping block that will not compromise the integrity of the tongue and groove of the floor being laid.

5. The tool of claim 1 will also house a separate piece that will be used as a template to cut the correct size flooring piece to fit in between the bolts of the tightening assembly.
